(19) United States
(12) Patent Application Publication
(10) Pub. No.: US 2014/0042648 A1
(43) Pub. Date: Feb. 13, 2014

(54) METHOD OF MAKING LENS MODULES

(71) Applicant: Wu-Li WANG, Tainan City (TW)

(72) Inventor: Wu-Li WANG, Tainan City (TW)

(21) Appl. No.: 13/584,021

(22) Filed: Aug. 13, 2012

(51) Int. Cl. B29D 11/00

(52) U.S. Cl. 264/1.36; 264/2.7

(57) ABSTRACT

A method of making lens modules includes the following steps: A. Provide a plurality of lens members on a die to form a runner between the lens members. B. Provide a housing material in the runner, and then curing the housing material. C. Remove the die to obtain a block. D. Cut the block to obtain a plurality of the lens modules. All kinds of lens modules may be applied in the method to make stronger and smaller lens modules.

### BACKGROUND OF THE INVENTION

1. Field of the Invention

The present invention relates generally to an optical device, and more particularly to a method of making lens modules.

2. Description of the Related Art

In recent days, consumer electronic devices, such as cell phone, laptop, tablet, and PDA, are equipped with lens module to catch images. These consumer electronic devices are made as smaller and lighter as possible for user to carry and operate in an easy way so that lens modules and the lens mounted in the lens module are asked smaller and lighter accordingly.

FIG. 1 shows a conventional lens module 50, including a substrate 52, an image sensor 54 on the substrate 52, a barrel 56 mounted on the substrate 52 to enclose the image sensor 54 therein, a lens 58 mounted in the barrel 56, and a housing 60 to enclose the above elements therein. The housing 60 is provided with an opening 62 above the lens 68. Fillers 74 are provided in a space between the housing 60 and the barrel 66.

The image sensor 54, barrel 56, and the lens 58 are stacked on the substrate 52, and then the housing 60 is fitted to the stack. Therefore, there always is space in the conventional lens module 50. Although we provide the fillers 66 to fill the space, and that may achieve the purpose of anti-shake and increase the structure strength. However, the fillers 74 increase the size and weight of the lens module 50 as well.

The conventional lens module 50 has the following drawbacks:

1. The structure strength still is weak even it has the fillers 66.

2. There is space between the top of the barrel 56 and the housing 60 and that would increase its height.

3. The lens modules of different specifications need different housings.

### SUMMARY OF THE INVENTION

The primary objective of the present invention is to provide a lens module and a method of making such lens module, which the lens module has strong structure, small size, and low cost.

According to the objective of the present invention, a method of making lens modules includes the following steps:

A. Provide a plurality of lens members on a die to form a runner between the lens members. The lens member has a substrate having a conductor pattern, an image sensor provided on the substrate and electrically connected to the conductor pattern, and above the image sensor.

B. Provide a housing material in the runner, and then curing the housing material. The housing material embeds the lens members except positions of the substrates which touch the die and portions of the lenses.

C. Remove the die to obtain a block; and

D. Cut the block to obtain a plurality of the lens modules.

In an embodiment, top centers of the lenses of the lens members are uncovered by the housing material.

In an embodiment, the method further has the step of providing solder bumps on the bottoms of the substrates after the step of removing the die.

In an embodiment, the method further has the step of providing solder balls on the bottoms of the substrates after the step of removing the die.

In an embodiment, the die is provided with a plurality of positioning portions to engage the substrates of the lens members.

In an embodiment, the positioning portions are recesses on the die, and shapes of the recesses are complementary to the substrates.

In an embodiment, the housing material is thermosetting material.

In an embodiment, the housing material is photo-curing material.

Therefore, All kinds of lens modules may be applied in the method of the resent invention to make stronger and smaller lens modules.

### BRIEF DESCRIPTION OF THE DRAWINGS

FIG. 1 is a sectional view of the conventional lens module;

FIG. 2 is a sectional view of the lens member of a preferred embodiment of the present invention;

FIG. 3 to FIG. 7 are sketch diagrams of making the lens modules by the method of the first preferred embodiment of the present invention; and

FIG. 8 is a sectional view of the lens module of the preferred embodiment of the present invention.

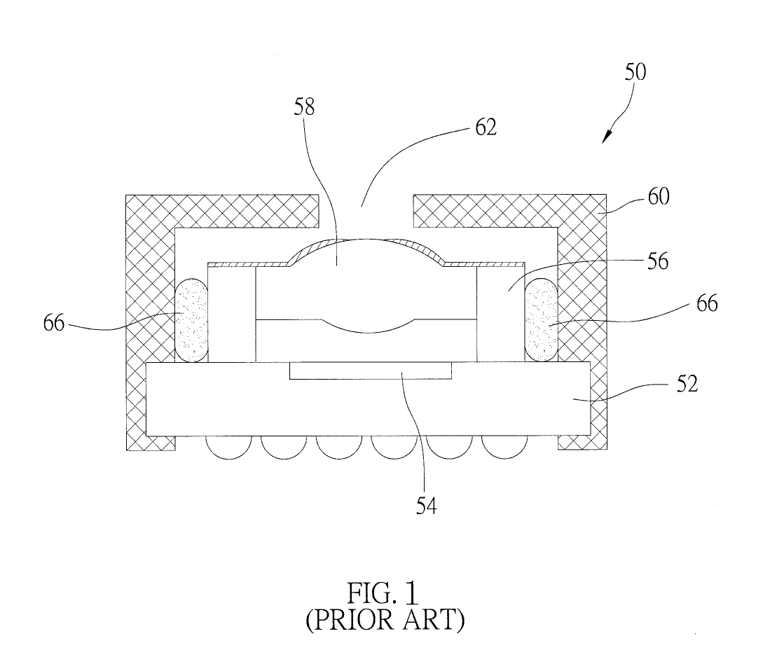

### DETAILED DESCRIPTION OF THE INVENTION

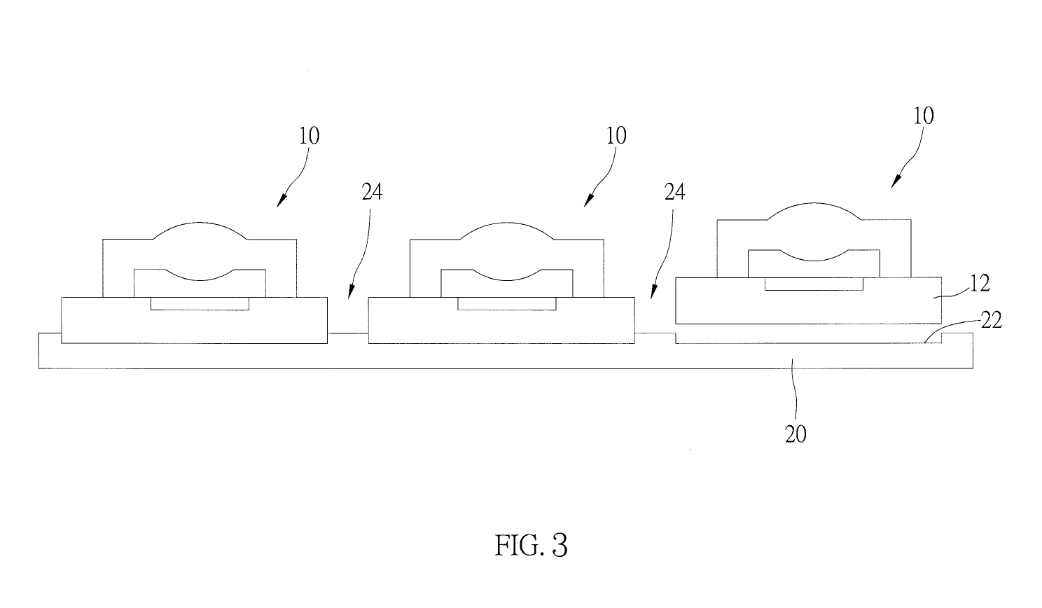

As shown in FIG. 3 to FIG. 8, a method of making lens modules of the first preferred embodiment of the present invention includes the following steps:

A. Put a plurality of lens members 10 on a die 20:

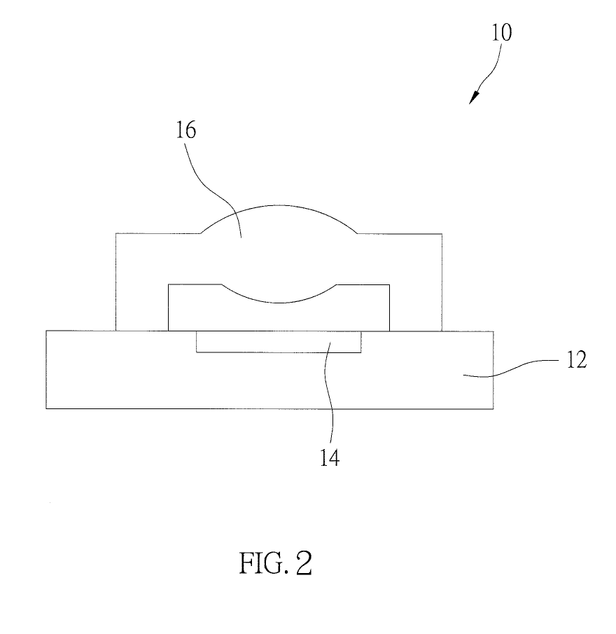

The lens members 10 are pre-made before performing the method of the present invention. Each lens member 10, as shown in FIG. 2, has a substrate 12 having a conductor pattern (not shown) thereon, an image sensor 14 provided on the substrate 12 and electrically connected to the conductor pattern, and a lens 16 mounted in the substrate 12 and above the image sensor 14. The die 20 has a plurality of positioning portions 22 which are recesses complementary to the substrates 12 that the lens members 10 may be firmly put in each positioning portions 22, as shown in FIG. 3, to form a runner 24 between the lens members 10.

B. Provide a housing material 30 in the runner 24, and then solidify it:

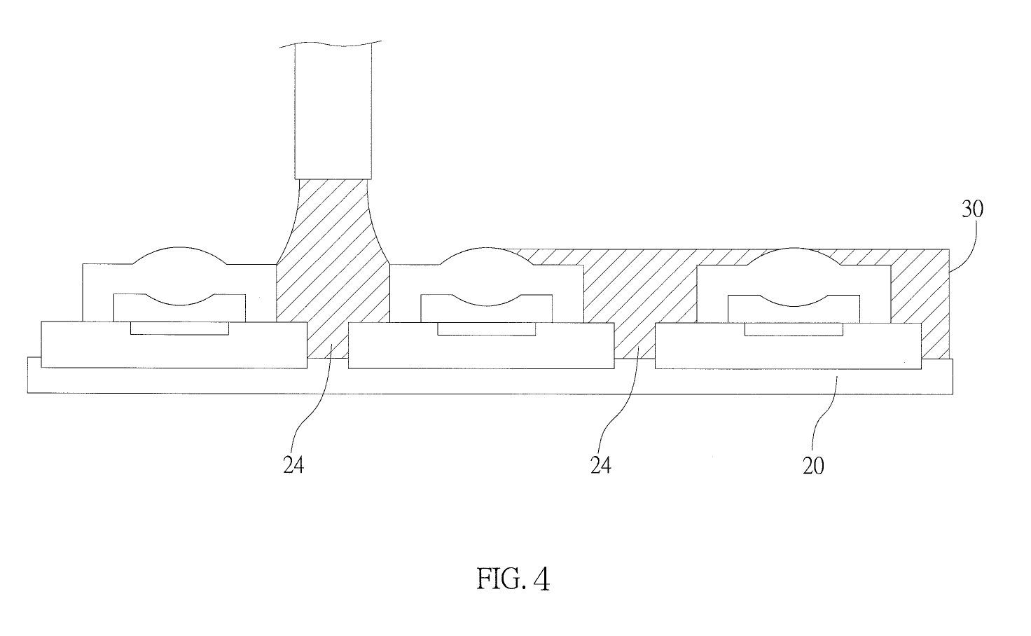

The housing material 30 is photo-curing material, and UV-curing epoxy is chosen in the present embodiment. As shown in FIG. 4, molten epoxy is poured into the runner 22. At this stage, the epoxy will embed the lens members 10 except for the bottoms of the substrates 12 which tightly touch the positioning portions 22 of the first die 20, and the portions of the lenses 16, precisely top centers of the lenses 16. Next, expose the epoxy under UV light to solidify it.

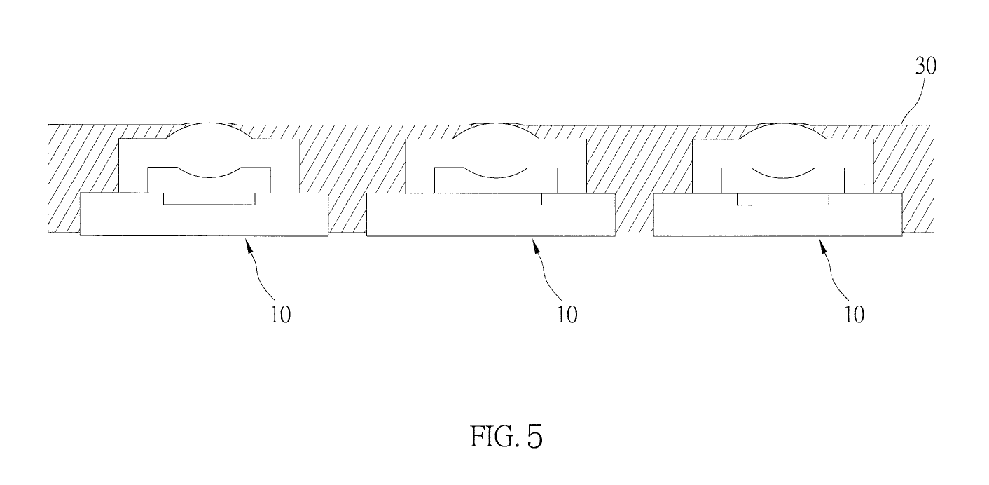

C. Remove the die 10, as shown in FIG. 5, to obtain a block of the solidified housing material 30. The lens members 10 are embedded in the block, and only the bottoms of the substrates 12 and the top centers of the lenses 16 are exposed.

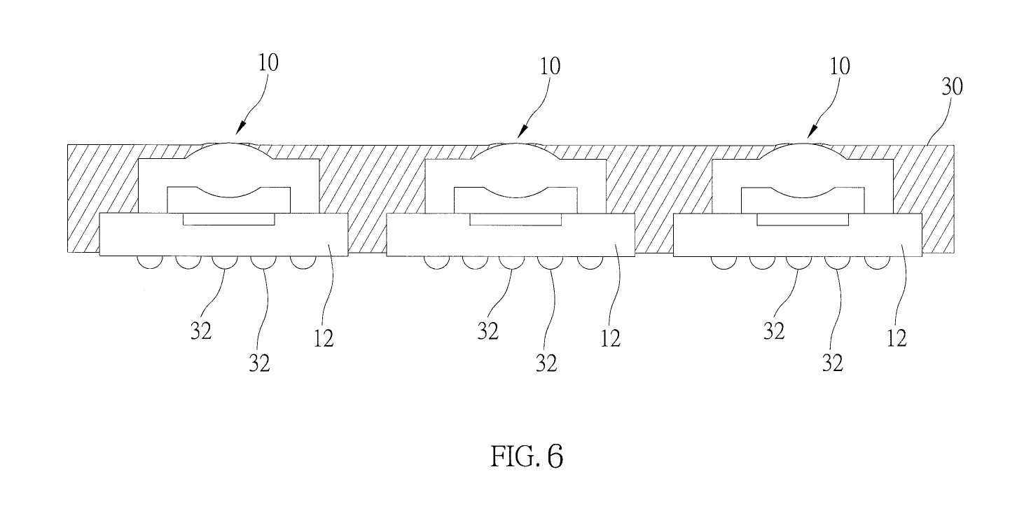

D. Providing solder bumps 32 on the bottoms of the substrates 12 of the lens members 10 to electrically connect to the conductor patterns respectively. As shown FIG. 6, ball plating is applied in the present step to make the substrates ball grid array (BGA) substrates, therefore, the conductor pattern may be electrically connected to another circuit through the solider balls 32.

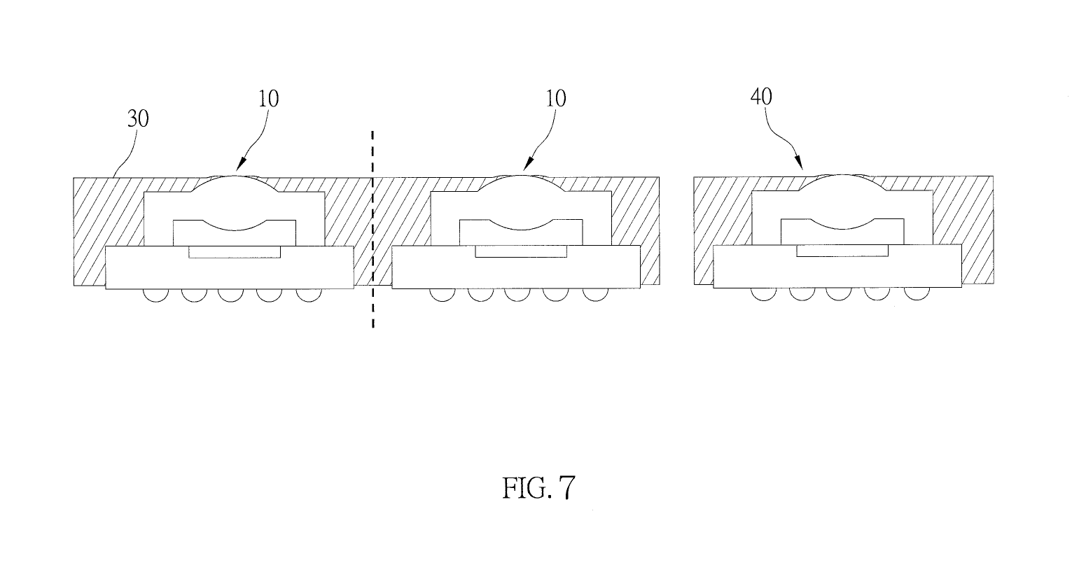

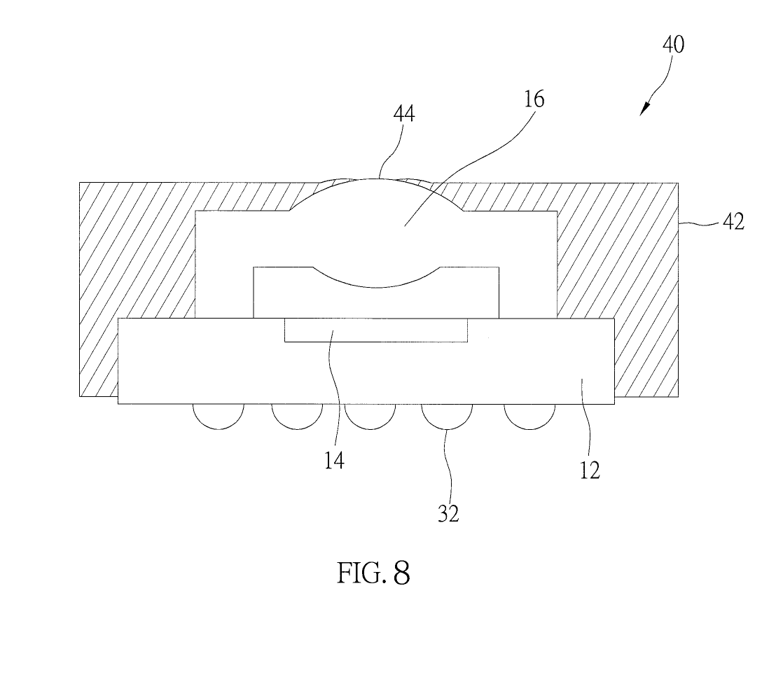

E. Cut the block, as shown in FIG. 7, to obtain a plurality of lens modules 40. As shown in FIG. 8, each lens module 40 includes a housing 42, which is formed by the housing material 30, and the lens member 10 embedded in the housing 42. The housing 42 has an opening 44 on a top to expose the top center of the lens 16. The opening 42 serves the function of aperture. The housing 42 has a cavity therein which is exactly complementary to the lens member 10 to embed it therein without any gap.

The lens module 40 made by the method of the present invention has the following advantages:

1. The housing 42 firmly embeds the lens member 10 therein without any gap therebetween to make the lens module 40 a firm rigid unit, and therefore, the lens module 40 will has a strong structure.

2. The height of the lens module 40 is reduced.

3. All kinds of lens members may be applied in the same process of the method of the present invention.

It is noted that the housing material may choose natural rubber, thermosetting epoxy, or other photo-curing or thermosetting materials except for the UV-curing epoxy as described in the embodiment. The lens member having two or more lenses may be applied in the method of the present invention as well. The description above is a few preferred embodiments of the present invention and the equivalence of the present invention is still in the scope of claim construction of the present invention.

What is claimed is:

1. A method of making lens modules, comprising the steps of:
providing a plurality of lens members on a die to form a runner between the lens members, wherein the lens member has a substrate having a conductor pattern, an image sensor provided on the substrate and electrically connected to the conductor pattern, and above the image sensor;
providing a housing material in the runner, and then curing the housing material, wherein the housing material embeds the lens members except positions of the substrates which touch the die and portions of the lenses;
removing the die to obtain a block; and
cutting the block to obtain a plurality of the lens modules.

2. The method as defined in claim 1, wherein top centers of the lenses of the lens members are uncovered by the housing material.

3. The method as defined in claim 1, further comprising the step of providing solder bumps on the bottoms of the substrates after the step of removing the die.

4. The method as defined in claim 1, further comprising the step of providing solder balls on the bottoms of the substrates after the step of removing the die.

5. The method as defined in claim 1, wherein the die is provided with a plurality of positioning portions to engage the substrates of the lens members.

6. The method as defined in claim 5, wherein the positioning portions are recesses on the die, and shapes of the recesses are complementary to the substrates.

7. The method as defined in claim 1, wherein the housing material is thermosetting material.

8. The method as defined in claim 1, wherein the housing material is photo-curing material.
